(19) United States
(12) Patent Application Publication
(10) Pub. No.: US 2009/0159365 A1
(43) Pub. Date: Jun. 25, 2009

(54) FIREMAN'S SAFETY APPARATUS AND METHODS OF USE

(76) Inventor: Dennis O'Brien, Woodstock, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/052,330

(22) Filed: Mar. 20, 2008

Related U.S. Application Data
(63) Continuation-in-part of application No. 11/962,373, filed on Dec. 21, 2007.

(51) Int. Cl. A62B 35/00

(52) U.S. Cl. 182/3

(57) ABSTRACT

Methods for utilization of a safety harness, particularly for use by firefighters is disclosed, wherein the strap comprises an elongated center section with four handles, two at each end extending from the elongated center section approximately opposite each other. The invention discloses a single easily deployable tool and methods which can at least carry S.C.B.A. cylinders and/or other equipment, work as a ladder belt and/or a hose strap, move charged lines, provide an increased search area, work as a hasty harness, work for dragging a victim or firefighter, work easily for Denver drill scenarios, and carry victims or firefighters up or down stairs.

### CROSS-REFERENCE TO RELATED APPLICATIONS

To the fullest extent permitted by law, the present continuation-in-part application claims priority to and the benefit of U.S. Non-provisional patent application entitled FIREMAN'S SAFETY APPARATUS AND METHODS OF USE, filed on Dec. 21, 2007, having Ser. No. 11/962,373.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### FIELD OF INVENTION

The present invention relates to a fireman's safety apparatus and methods of use, more particularly to a strap apparatus having multiple uses as a rescue device and utility apparatus.

### BACKGROUND ART

There are various types of fire rescue and fire safety devices in existence. One device discloses a carrier apparatus for use by fire fighters to carry fire hoses, and to serve as a personnel carrier. The device comprises a carrier body of material about five feet long having a bottom and side walls, and at one end there is an end wall, and portions of the side walls adjacent the end wall being perpendicular to the bottom and end wall. Handles and securing straps are provided. A continuous length of fire hose is placed in two side by side stacks, with a connecting portion from one stack to the other; a strap with hook and pile type fastener, such as sold under the trademark VELCRO fastener extends around one stack and is released by force applied through the connecting portion of the fire hose.

Another device discloses an apparatus for assisting a fireman or rescue worker in gripping an immobile victim's limb or allowing an immobile person to secure his limbs around the rescuer during an emergency situation. It includes two adjustable strap members made out of nylon, an aluminum buckle attached to each strap member, and a spring closure latch disposed within one of the buckles to engage the other buckle.

Still another device discloses an apparatus for moving an individual. The apparatus includes a fitting attached to one end of a pole. The fitting is shaped and dimensioned to engage an individual's clothing by being pressed against the clothing and rotated.

Yet another device discloses a floatable marine rescue snare comprising one or more buoyant elongate rods axially connected by a tie line and formed in a loop, with a slippage device fixed to one end of the snare and slidably engaged with a portion of the snare between its two ends. The tie line connects to a rescue rope by which it may be thrown to a victim. Once looped around the upper torso of the victim, the snare can be tightened by pulling on the rescue rope to secure a rescue link while the buoyant body of the snare maintains the victim afloat.

Another device discloses a fireman's coat and drag harness. The drag harness includes first and second work portions received within the coat adjacent the corresponding arm portions thereof. The loop portions extend about corresponding arms of the wearer of the coat. A drag loop is operatively connected to the first and second loop portions. The drag loop extends through an opening in the torso portion of the coat so as to allow a potential rescuer to grasp the drag loop in order to drag an incapacitated person to safety.

Still another device discloses a personal wear throw bag lifeline rescue apparatus providing a lifeline-containing bag member arranged for quick release attachment to a wearer, the lifeline being secured at one of its ends to the interior of the bag member and arranged at its opposite outer, free terminal end for secure attachment to the wearer, whereby in an emergency situation the bag member may be grasped and pulled off of the wearer and thrown, carried or otherwise moved to a distant location defined by the overall length of the lifeline cord where a rescuing person may pull on the lifeline to pull the wearer connected to the lifeline to safety.

Yet another device discloses a rescue harness for fire rescue personnel, preferably including: a flexible head/neck support member for supporting a victim's head and neck when the harness is being used to pull the victim to safety, the flexible support member optionally extending over the victim's back to cover air tanks or other gear; a chest strap with attachment means at each end of the strap, suitable for holding the victim in the harness by buckling the strap around the person's chest; and a grip attached to upper edge of the head support, the grip being suitable for use by gloved firefighters for pulling a person strapped in the harness from a building. The rescue harness also includes a second strap for further retaining the victim, the second strap having one end fixedly attached to the first strap, and having a second and releasably attached to the first strap with a buckle.

Another device discloses a convertible harness including a waist strap, shoulder straps and a stowable pelvis enclosing assembly. In one embodiment, the pelvis enclosing assembly includes a pouch attached to the back of the harness, two leg loops, a crotch strap and an attachment mechanism. A wearer releases the stowable pelvis enclosing assembly from the pouch, brings the crotch strap through his legs, attaches the attachment mechanism to an attachment point at the front of the harness and tightens the strap. This converts the harness into a full body harness. The harness also includes a stowable rappelling assembly, which includes a rappel assembly pouch, an anchor mechanism, a descender, a rappel line and a harness attachment mechanism. The wearer pulls the anchor mechanism from the pouch, attaches the descender to an attachment point at the front of the harness, anchors the anchor mechanism and rappels using the assembly.

Still another device discloses an improved rescue harness which simultaneously attaches a transporting rescuer to an injured or unconscious person. The longitudinal shoulder loops, as well as rectangular headrest which supports an injured person's head and neck, allows the rescuer worker to securely and quickly transport a person upon an uneven surface. Other features include the use of flexible materials which are lightweight, and heavy-duty self-locking carabiner clips which attach to the injured person's equipment.

Yet another device discloses an apparatus generally used as a rescue device that a firefighter or other personnel may utilize to pull or carry a victim out of a fire or away from a place or peril. The device may be utilized by one single person to rescue another person. The device is made from standard web materials that are sewn in place and has a web belt feature built in to permit the rescuer to secure the victim. The belt of the device encircles the victim and is fastened at the ends of the belt. The device is then used to pull the victim to safety.

Another device discloses two handles attached through a metal ring to an extension of fabric with a second metal ring on the second end of the extension of fabric. The device is primarily used to retrieve a downed firefight, but is also used as a strap to carry equipment.

Still another device discloses two fabric rings around a larger third ring and is primarily utilized to drag a victim, haul equipment or as a short search line.

Yet another device discloses a handle attached to a length of fabric, wherein the length of fabric is joined by a plastic clip, buckle or d-ring. The device is primarily used to strap around any object and sinch the device tight to aid in carrying the object.

Another device discloses five large loops of fabric secured in a chain and is utilized primarily for carrying people and firefighter equipment.

Other devices are for carrying specific firefighter equipment, such as self-contained breathing apparatus (S.C.B.A.) cylinders. One such device is made of fabric and comprises three rings. One of the rings has a plastic handle for lifting the tanks while the other two rings are secured around the S.C.B.A. tank valves to allow a fireman to carry additional S.C.B.A. cylinders.

While all of these devices may serve other intended functions, they generally fail to provide a tool for firefighters that is easily and quickly capable of a full range of services and functions for which a firefighter generally finds a need. Specifically, none of the devices provide a single easily deployable tool which can carry S.C.B.A. cylinders and/or other equipment, work as a ladder belt and/or a hose strap, move charged fluid lines or hoses, provide an increased search area, work as a hasty harness, work for dragging a victim or firefighter, work easily for Denver drill scenarios, such as for pulling a fireman over a sill, and for carrying victims or firefighters up or down stairs.

Therefore, it is readily apparent that there is a need for a fireman's safety apparatus and methods of use which minimizes and/or overcomes these deficiencies by providing a full range of desired firefighting and rescue function from a single, compact and functional tool. This would serve the functions of reducing cost, time, inefficiencies, and save lives while providing a durable and easy to use multi-function firefighter's tool.

### SUMMARY OF THE INVENTION

Briefly described, in a preferred embodiment, the present invention overcomes the above-mentioned disadvantages and meets the recognized need for such a device by providing a fireman's safety apparatus and methods of use, wherein the fireman's safety apparatus comprises a strap, preferably for use by firemen or other emergency rescue personnel, and wherein the strap comprises a generally elongated center section with four handles, two at each end extending therefrom. The strap has multiple uses including, but not limited to carrying, moving and/or lifting equipment, downed firefighters, civilians and/or others. Accordingly, a firefighter or similar member of rescue personnel can carry a single device which is easy to remove from its storage pouch and can perform multiple rescue and utility operations as needed for the situation.

According to its major aspects and broadly stated, the present invention in a preferred form is a fireman's safety apparatus and methods of use, wherein the fireman's safety apparatus is a strap comprising a first end, wherein the first end comprises a first fold and a first tip, a second end, wherein the second end comprises a second fold and a second tip, a center section, a first band disposed at the first end, wherein the first band comprises a first handle and a second handle, and a second band disposed at the second end, wherein the second band comprises a third handle and a fourth handle. Thus, a strap is provided with four handles to provide additional functionality and use to a firefighter or other rescue personnel.

In a preferred embodiment, the strap is approximately 48 inches in length and the first handle, the second handle, the third handle and the fourth handle are approximately 7.5 inches in length. Testing of the fire strap has shown 48 inches is an appropriate length for the fire strap because it still allows for easy storage on a firefighter while providing maximum distance for utilization as a rescue tool. Additionally, a length of 7.5 inches for the handles is preferred because it allows a gloved hand to easily be inserted through the handle while still providing a tight fit around objects or people to be carried. One skilled in the art would recognize that although specific dimensions are given, the dimensions are meant without limitation and the fire strap could alternatively be longer and folded more times during storage within a pouch or shorter, and similarly the handles could also be longer or shorter.

In another preferred embodiment, the strap is made of fire resistant materials. Additionally, the strap could comprise nylon, KEVLAR, and/or other materials which are generally strong yet flexible. In lieu of fire resistant materials, it would also be possible to coat the strap in a fire resistant coating, as is known in the art, to reduce the likelihood of fire and/or heat damage to the strap. It is preferable to have the strap made of fire resistant or fire proof materials to prevent degradation of the strap during use and further a strong material is needed as the fire strap is intended to life one more heavy objects. One skilled in the art would recognize specific materials are listed as preferred embodiments of the present invention and are for exemplary purposes only and are not meant to be limiting, as other materials could be utilized.

In still another preferred embodiment, the first handle and the second handle extend from the first end of the center section at a substantially right angle, and wherein the third handle and the fourth handle extend from the second end of the center section at substantially a right angle. The first handle and the second handle may also extend in opposite directions from each other and the third handle and the fourth handle extend in opposite directions from each other in a preferred embodiment. Having the handles protrude from the strap at approximately a 90 degree angle allows for the handles to stay generally stationary with respect to the center section of the strap, making them easier to locate and more functional and also providing a strong point for securing the handles to the center section of the strap.

In yet another preferred embodiment, the first handle, the second handle, the third handle and the fourth handle are folded lengthwise to form double thickness. Folding the handles and doubling the thickness provides reinforcement to the handles while also making them thinner and more manageable by rescue personnel.

In a preferred embodiment, the center section comprises a first portion, a second portion and a middle portion and the first tip is fixedly secured to the first portion, thereby forming the first fold, and wherein the second tip is fixedly secured to the second portion, thereby forming the second fold. Thus, the first portion of center section is folded over a portion of the first band and the second portion of the center section is folded over a portion of the second band and is preferably secured via stitching. Thus, the first band and the second band which comprise the handles is secured to the center section in a manner that is stronger than simply stitching the bands to the center section, thereby reducing the likelihood of the fire strap breaking or coming apart during use.

In another preferred embodiment, the first band comprises first termination and second termination, and wherein the first termination and the second termination are fixedly secured to the first end, and wherein the second band comprises third termination and fourth termination, wherein the third termination and the forth termination are fixedly secured to the second end. Additionally, the first termination and the second termination are disposed within the first fold wherein the third termination and the fourth termination are disposed within the second fold. Thus, the termination points of the bands are secured within the folds created by folding the center section. In this manner, the tensile strength of the fire strap is improved due to the multiple layers of material secured together. In a preferred embodiment, the securing of the fire strap is done through stitching; however, one skilled in the art would recognize that other means of securing the bands to the center section could be used, including, without limitation, adhesives, staples, rivets, other fastening devices and/or any combination thereof.

In still another preferred embodiment, a first central band portion of the first band is secured at the first end outside of the first fold, and wherein a second central band portion of the second band is secured at the second end outside of the second fold. In addition to the tips being secured within the folds of the center section, the central portions of the bands are secured to the outside of the fold, thereby creating five (5) layers of material which are secured together, creating a particularly strong bond between the bands and the center section.

In a preferred embodiment, the strap further comprises a pouch and in a further preferred embodiment, the pouch is dimensioned to contain the strap when the strap is folded into third portions. Specifically, in a preferred embodiment, the pouch is approximately 14 inches in length and the pouch is approximately 18 inches in width. Having the strap tri-folded lengthwise facilitates easy storage as well as quick deployment of the strap, while the pouch is of a size suitable for storing the tri-folded strap. One skilled in the art would recognize that although specific dimensions are given, the dimensions are meant without limitation and the pouch could alternatively be longer and wider or shorter and skinnier dependant on the size of the strap.

The pouch could comprise nylon, KEVLAR, and/or other materials which are generally strong yet flexible. It is preferable to have the pouch made of fire resistant or fire proof materials to prevent degradation of the pouch during use. Alternatively, the pouch could be coated in a fire resistant or fire proof coating to prevent degradation of the pouch. One skilled in the art would recognize specific materials are listed as preferred embodiments of the present invention and are for exemplary purposes and are not meant to be limiting, as other materials could be utilized.

In another preferred embodiment, the pouch further comprises an outside fastener, wherein the outside fastener is disposed on an outside of the pouch. In a further preferred embodiment, the outside fastener further comprises a first side and a second side, and wherein the first side further comprises a multitude of pile and the second side further comprises a plurality of hooks, and wherein the first side and the second side fasten when the first side comprising the multitude of pile contacts the second side comprising the plurality of hooks. Thus, the outside fastener is secured to the pouch and is utilized to secure the pouch, preferably containing the strap, to a rescue worker. In a preferred embodiment, the pouch is secured to the S.C.B.A. frame of rescue personnel, although the pouch may be removably or fixably secured to any portion of rescue personnel and/or their equipment. Additionally, the hook-and-loop type fastener allows for the quick and easy removal and replacing of the pouch to the S.C.B.A. frame. Although a hook-and-loop type fastener is described as a preferred embodiment, one skilled in the art would recognize alternative forms of securing the pouch to the S.C.B.A. frame or other portions of the firefighter or equipment is equally possible using different types of fasteners such as, without limitation, snaps, ties, adhesives, rivets, stitching and/or any combination thereof.

In still another preferred embodiment, the pouch further comprises a first fastener on a left periphery of the pouch, wherein the first fastener further comprises a first left periphery side of pile and a second left periphery side of hooks, and wherein the first left periphery side of pile and the second left periphery side of hooks fasten when in contact. The pouch additionally comprises a second fastener on a right periphery of the pouch, wherein the second fastener further comprises a first right periphery side of pile and a second right periphery side of hooks, and wherein the first right periphery side of pile and the second right periphery side of hooks fasten when in contact. The pouch further comprises a third fastener on an upper center periphery and a lower center periphery of the pouch, wherein the third fastener further comprises an upper center periphery side of pile and a lower center periphery side of hooks, and wherein the upper center periphery side of pile and the lower center periphery side of hooks fasten when in contact. In this manner, the pouch is bi-folded and secured with hook-and-loop type fasteners to keep the pouch in a closed position; however, when enough force is applied to the handles protruding from the pouch, the pouch easily opens for dispensing the strap. Again, one skilled in the art would recognize alternative forms of securing the pouch in a closed position other than hook-and-loop type fasteners, such as, without limitation, snaps, ties, temporary adhesives, breakable stitching and/or any combination thereof.

In a further preferred embodiment, the first left periphery side of pile of the first fastener is disposed on an upper portion of the left periphery of the pouch, and the second left periphery side of hooks of the first fastener is disposed on a lower portion of the left periphery of the pouch. The first right periphery side of pile of the second fastener is disposed on the upper portion of the right periphery of the pouch, and the second right periphery side of hooks of the second fastener is disposed on the lower portion of the right periphery of the pouch. The upper center periphery side of pile of the third fastener is disposed on the upper center periphery of the pouch, and the lower center periphery side of hooks of the third fastener is disposed on the lower center periphery of the pouch. Testing of the strap and pouch has shown it is preferable to have the pile portion of fasteners as the upper part of the fastener to prevent the strap from catching on the hooks during deployment. Additionally, hook-and-loop type fasteners are beneficial for their quick release, yet fastening power and in the present case allow for quick removal of the strap from the pouch. One skilled in the art would recognize alternative forms of securing the pouch in a closed position other than VELCRO-type fasteners, such as, without limitation, snaps, ties, temporary adhesives, breakable stitching and/or any combination thereof.

In still another preferred embodiment, the third fastener is substantially less in width than the width of the pouch, thereby allowing the first handle and the third handle to protrude from the pouch or alternatively, the second handle and the fourth handle to protrude from the pouch. Having two handles protruding from the pouch allows one to be grabbed from either side of the user, thereby enabling the user to near instantaneously wrap the strap around his body for rescue. Additionally, having a handle on each side make the strap suitable for ambidextrous utilization. Accordingly, a user can pull on either the left side or the right side to remove the strap from the pouch.

In a preferred use, a method of deploying a strap is provided, wherein the method comprises the steps of securing a pouch to a person, wherein the pouch contains the strap, and wherein the strap comprises a first end, a second end and a center section, and wherein the first end comprises a first handle and a second handle, and wherein the second end comprises a third handle and a fourth handle, and wherein the first handle and the third handle protrude from the pouch, pulling the first handle, and wherein the pulling removes a first end of the strap from the pouch. This method of deployment is particularly useful if a rescuer wishes to completely remove the strap from the pouch without securing the strap around the body of the rescuer. The strap is quickly and easily removed from the pouch on one side and is ready for immediate use.

In a further preferred use, the rescuer also pulls the third handle, wherein the pulling removes a second end of the strap from the pouch, thereby providing the first end on a first side of the person and the second end on a second side of the person. In this manner, the strap is quickly and easily deployed from the storage position within the pouch fastened on the user and is deployed in a manner which is appropriate for rescuing the user or securing the user to a point, such as, for exemplary purposes only, a ladder. The handles are pulled by the wearer of the pouch or alternatively may be pulled by rescue personnel to assist in moving the wearer of the pouch and strap.

In another preferred use, a method of using a strap is provided, wherein the method comprises the steps of obtaining a strap having a first end, a second end and a center section, wherein the first end comprises a first handle and a second handle, and wherein the second end comprises a third handle and a fourth handle, wrapping a first end and a second end of the strap around a user, wrapping a first handle of the first end of the strap around a portion of a ladder, and securing the first handle disposed on the first end of the strap to a second handle disposed on the second end of the strap. Accordingly, the strap can be utilized to secure a rescuer to a ladder reduce the likelihood of falling and the method further provides stabilization of the rescuer while on the ladder. One skilled in the art would recognize that although securing a rescuer to a ladder is specifically contemplated, the strap could be utilized to secure a rescuer to near any non-flat surface. Additionally, one skilled in the art would recognize that although first and third handles are specifically mentioned, it would be equally possible to secure the second handle and the fourth handle together. Further, the second handle and the fourth handle could protrude from the pouch and be pulled by a rescuer instead of the first handle and the third handle.

In still another preferred use, a method of using a strap is provided, wherein the method comprises the steps of obtaining a strap having a first end, a second end and a center section, wherein the first end comprises a first handle and a second handle, and wherein the second end comprises a third handle and a fourth handle, wrapping a first end of the strap around an anchor point, and securing the first end of the strap to a second end of the strap. In this manner, a rescuer can be anchored to a point thereby allowing the rescuer to reach beyond the normal limitations while preventing the rescuer from falling. Again, and as with most uses, the first handle and second handle are interchangeable in use as is the third handle and fourth handle, as the first end and second end of the strap are substantially mirror images as is the top half and bottom half of the strap.

In yet another preferred use, a method of moving an object is provided, wherein the method comprises the steps of obtaining a strap having a first end, a second end and a center section, wherein the first end comprises a first handle and a second handle, and wherein the second end comprises a third handle and a fourth handle, securing the strap to the object, and pulling the strap to move the object. In this manner, objects of most dimensions, including without limitation, humans and other living objects can be transported with the strap.

In a further use of the strap in which an object is moved, the method further comprises the steps of inserting a first hand into the first handle of the strap, inserting a second hand into the second handle of the strap, passing the second end of the strap over the first end of the strap, and pulling on the second end of the strap, thereby tightening the first handle around the first hand and tightening the second handle around the second. In this manner, the strap is secured around the hands, feet and/or wrists of a rescuee to facilitate moving a person while taking advantage of the maximum length of the strap and the added length of outstretched arms. One skilled in the art would recognize that the second end of the strap may alternatively be passed under the first end of the strap and brought back toward the rescuer to tighten the strap as a wrist wrap.

In still a further use of the strap in which an object is moved, the method further comprises the steps of wrapping the first end of the strap around an object or through an aperture of an object, and securing the first end of the strap to the second end of the strap, preferably via carabiner. In this manner, an object having a handle or similar protrusion or aperture on which the strap is secured can be easily and quickly transported. Although using a carabiner is specifically contemplated other means of securing the ends together would be recognized by one skilled in the art to function equivalently.

In a further use of the strap in which an object is moved, the method further comprises the steps of securing a frame to a person, wherein the frame is secured to the person via a harness, securing a pouch to the frame, wherein the pouch contains the strap, and wherein the first handle of the strap and the third handle of the strap protrude from the pouch, pulling the first handle, wherein the pulling removes the first end of the strap from the pouch, pulling the third handle, wherein the pulling removes the second end of the strap from the pouch, thereby providing the first handle on a first rear side of the person and the third handle on a second rear side of the person, pulling the first handle and the third handle in a substantially upward direction, thereby securing the strap to the harness, and pulling the first handle and the third handle of the strap, thereby applying force to move the person. In this manner a rescuer is moved by pulling on the strap which is secured to the harness to lift the rescuer to safety in a quick and efficient manner.

In a further use of the strap in which an object is moved, the method further comprises the steps of securing a harness to a person, securing the first end of the strap to the harness, preferably via carabiner, wrapping the second end of the strap across the body of the person, pulling the second end of the strap between the legs of the person, thereby creating a saddle in which the person is seated, and pulling the second end of the strap to move the person. In this manner a saddle-type seat is created for the rescuee, thereby supporting the rescuee during the pulling process while quickly and efficiently moving the rescuee.

In a further use of the strap in which an object is moved, the method further comprises the steps of placing the center section of the strap under the legs of a person, wrapping the first end of the strap around a first leg of the person, wrapping the second end of the strap around a second leg of the person, wrapping the first handle disposed on the first end underneath the center section of the strap, inserting the second handle disposed on the first end of the strap through the first handle disposed on the first end of the strap, wrapping the third handle disposed on the second end underneath the center section of the strap, inserting the fourth handle disposed on the second end of the strap through the third handle disposed on the second end of the strap, pulling the second handle disposed on the first end of the strap through the first handle disposed on the first end of the strap, thereby tightening, pulling the fourth handle disposed on the second end of the strap through the third handle disposed on the second end of the strap thereby tightening, and lifting the second handle and the fourth handle to lift the legs of the person. In this manner, the legs of a rescuee can be secured. This is particularly advantageous when two or more rescuers are carrying a rescuee up or down stairs and one rescuer is responsible for supporting the upper body and the second rescuer is responsible for supporting the legs. Typically a rescuer must get very close when carrying by the legs often obscuring visibility. Further, clothes can be burned, torn or otherwise difficult to grasp, as can the legs themselves. When the strap is utilized as a leg wrap grabbing by the clothes is not necessary, a rescuer has better visibility and a better grip is provided, reducing the chances of dropping the rescuee and easing the burden on the rescuer.

In a further use of the strap in which an object is moved, the method further comprises the steps of wrapping the first end and the second end of the strap around a person, and pulling the first end and the second end of the strap to move the person. The strap, when utilized in this method, simplifies the process of moving a rescuee by providing handles secured to the user, thus allowing the rescuer to move the rescuee from a more comfortable position, thereby easing the burden on the rescuer while still providing a faster rescue to the rescuee. In an additional use, the first end of the strap is secured to the second end of the strap. Although using a carabiner is specifically contemplated other means of securing the ends together would be recognized by one skilled in the art to function equivalently. Use of the carabiner with the hasty harness is particularly useful when hoisting the rescuee or if a rope or other object needs to quickly be secured to the strap. One skilled in the art would recognize once the strap has been secured to a rescuee, the strap can then be pulled in at least a vertical, horizontal direction or an angle between and further that the pulling may be accomplished, without limitation, by people, animals, machines and/or any combination thereof to aid in moving the person or object.

In a further use of the strap in which an object is moved, the method further comprises the steps of inserting a first object to be transported, or portion thereof, into at least one handle on the first end of the strap, and inserting a second object to be transported, or portion thereof, into at least one handle of the second end of the strap. This method is particularly useful for moving and carrying S.C.B.A. tanks. Utilizing the strap in this method enables rescue personnel to carry at least two (2), but preferably four (4) additional S.C.B.A. tanks versus having to take multiple trips. Thus, the strap provides a more efficient manner of transporting S.C.B.A. tanks. In a preferred embodiment, the strap can be secured over the shoulder of the rescue personnel or can be secured around the S.C.B.A. tank on its frame, thereby leaving the hands of the rescue personnel free to carry more objects or to function in another manner.

In a further use of the strap in which an object is moved, the method further comprises the steps of placing the center section of the strap under the legs of a person, wrapping the first end of the strap around a first leg of the person, wrapping the second end of the strap around a second leg of the person, securing the first end of the strap to the second end of the strap, and lifting the first end of the strap and the second end of the strap to lift the legs of the person. In this alternate version of a leg wrap, the rescuee can be easily and quickly lifted by the legs. In an additional embodiment, the first end of the strap and the second end of the strap are secured to the center section of the strap, preferably via carabiner, thereby securing the strap to itself around the legs of the rescuee and facilitating easy transportation of the rescuee while minimizing stress and slips.

In a further use of the strap in which an object is moved, the method further comprises the steps of wrapping the first end and the second end of the strap through a harness, wherein the harness is secured to a person, and pulling the first end and the second end of the strap to move the person secured to the harness. In this manner, a rescuer can deploy the strap and secure the strap to a rescuee to move the rescuee from danger in a quick and efficient manner. In a further embodiment, the first end of the strap is secured to the second end of the strap, preferably via carabiner, thereby allowing ropes or other hoisting materials to be secured to a carabiner or similar mechanism to pull the rescuee to safety.

In a preferred use of the strap in which a person is moved, a rescuee or injured person can sit on the center section of the strap while the first end and second end of the strap are carried by at least one rescuer. Alternatively, a heavy object could be placed on the seat created by the strap instead of a person. Similarly, multiple straps could be utilized if necessary to create a makeshift gurney with rescuers holding and supporting each side of the strap to move a person or object that is laid out on the multiple straps. In this manner, a rescuee can quickly be removed from dangerous situations without having to drag the rescuee.

In still a further preferred use of the strap, wherein the method comprises the steps of obtaining a strap having a first end, a second end and a center section, wherein said first end comprises a first handle and a second handle, and wherein said second end comprises a third handle and a fourth handle, a first rescuer pulls the first end of the strap along a surface while a second rescuer pulls the second end of the strap along the same surface. In this manner, a room with very low visibility can be searched by using the strap as a search line to see if there is a person or other item on the surface, wherein each fireman retains hold of one end of the fireman's safety strap to prevent separation from the other fireman.

Accordingly, a feature and advantage of the present invention is its ability to provide a multifunction tool for rescue personnel.

Another feature and advantage of the present invention is its ability to quickly and easily deploy in a useable condition for moving objects or rescuing people.

Still another feature and advantage of the present invention is its ability to provide multiple ways of removing a person from a dangerous situation, such as a fire.

Yet another feature and advantage of the present invention is its four handles to provide extra leverage and functionality to the strap.

Yet still another feature and advantage of the present invention is the pouch to hold the strap in a position which is easily accessed by a rescuer.

A further feature and advantage of the present invention is its ability to save lives in a quick and efficient manner.

Accordingly, a feature and advantage of the present invention is its ability to function as a ladder belt.

Another feature and advantage of the present invention is its ability to function as an anchor strap.

Still another feature and advantage of the present invention is its ability to function as a wrist wrap.

Yet another feature and advantage of the present invention is its ability to function as a seat or saddle for removing a rescuee.

Yet still another feature and advantage of the present invention is it ability to function as a hasty harness.

A further feature and advantage of the present invention is its ability to carry multiple objects.

Accordingly, a feature and advantage of the present invention is its ability to function as a leg wrap for carrying the legs of a rescuee.

Another feature and advantage of the present invention is its ability to facilitate rescue during Denver drill scenarios.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to the elements throughout, and in which:

FIG. 1A shows a top view of a preferred embodiment of a fireman's safety apparatus;

FIG. 1B shows a cross section of an end a preferred embodiment of a fireman's safety apparatus;

FIG. 2 shows a top view of a preferred embodiment of a fireman's safety apparatus with associated pouch in an opened position, showing the inside of the pouch;

FIG. 3 shows a bottom view of a preferred embodiment of a fireman's safety apparatus with associated pouch in an opened position, showing the outside of the pouch;

FIG. 4 shows a bottom view of a preferred embodiment of a fireman's safety apparatus with associated pouch for the fireman's safety apparatus in closed position with handles of the fireman's safety apparatus protruding from the pouch;

FIG. 5 shows a top view of a preferred embodiment of the a fireman's safety apparatus with associated pouch, showing the inside of the pouch with the fireman's safety apparatus tri-folded within the pouch;

FIG. 6 shows a rear perspective view of a preferred embodiment of the fireman's safety apparatus in use during deployment;

FIG. 7 shows a rear perspective view of a preferred embodiment of the fireman's safety apparatus in use secured around a fireman's harness for moving a fireman;

FIG. 8 shows a top perspective view of a preferred embodiment of the fireman's safety apparatus in use secured around a fireman's harness for moving a fireman;

FIG. 9 shows a front perspective view of a preferred embodiment of the fireman's safety apparatus in use secured around a fireman's harness for moving a fireman;

FIG. 10 shows a rear perspective view of a preferred embodiment of the fireman's safety apparatus in use securing multiple S.C.B.A. tanks over a harness, S.C.B.A. frame and S.C.B.A. tank of a fireman;

FIG. 11 shows a side perspective view of a preferred embodiment of the fireman's safety apparatus in use securing a saw over the shoulder of a fireman;

FIG. 12 shows a side perspective view of a preferred embodiment of the fireman's safety apparatus in use as a ladder belt;

FIG. 13 shows a side perspective view of a preferred embodiment of the fireman's safety apparatus in use as an anchor strap;

FIG. 14 shows a front perspective view of a preferred embodiment of the fireman's safety apparatus in use for securing and lifting the legs of a person;

FIG. 15 shows a front perspective view of another preferred embodiment of the fireman's safety apparatus in use for securing and lifting the legs of a person;

FIG. 16 shows a rear perspective view of a preferred embodiment of the fireman's safety apparatus in use for moving a fireman;

FIG. 17 shows a front perspective view of a preferred embodiment of the fireman's safety apparatus secured to a fireman's harness in use as a saddle for moving a fireman;

FIG. 18 shows a top perspective view of a preferred embodiment of the fireman's safety apparatus in use as a wrist wrap for moving a person;

FIG. 19 shows a front perspective view of a preferred embodiment of the fireman's safety apparatus in use for moving a person; and

FIG. 20 shows a front perspective view of a preferred embodiment of the fireman's safety apparatus in combination with a carabiner for moving a person.

### DETAILED DESCRIPTION OF THE PREFERRED AND SELECTED ALTERNATE EMBODIMENTS

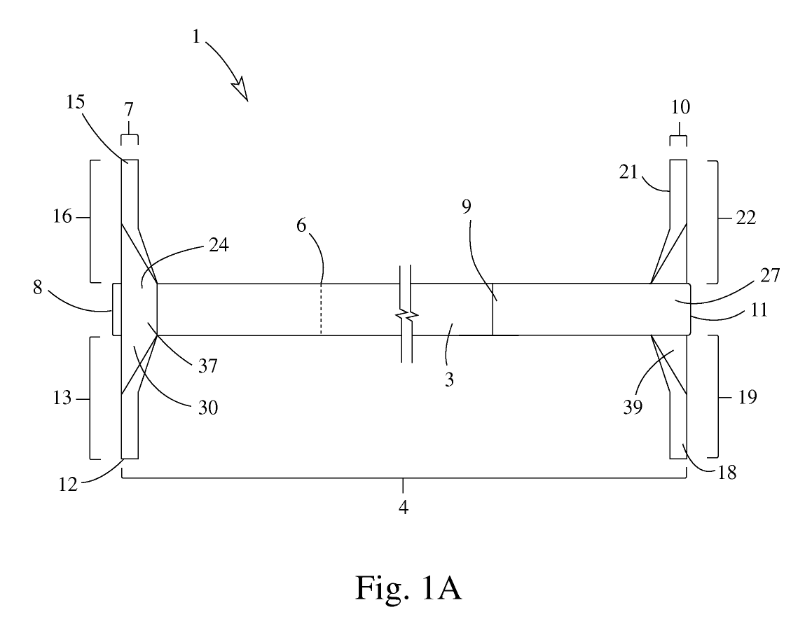

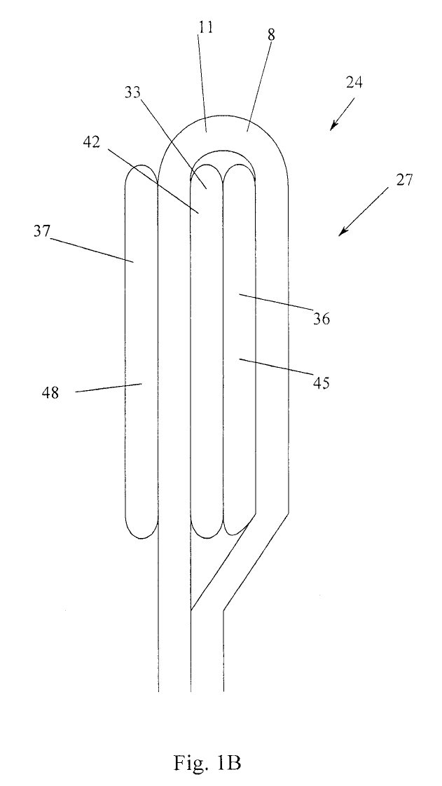

In describing the preferred and selected alternate embodiments of the present invention, as illustrated in FIGS. 1A-20, specific terminology is employed for the sake of clarity. The invention, however, is not intended to be limited to the specific terminology so selected, and it is to be understood that each specific element includes all technical equivalents that operate in a similar manner to accomplish similar functions.

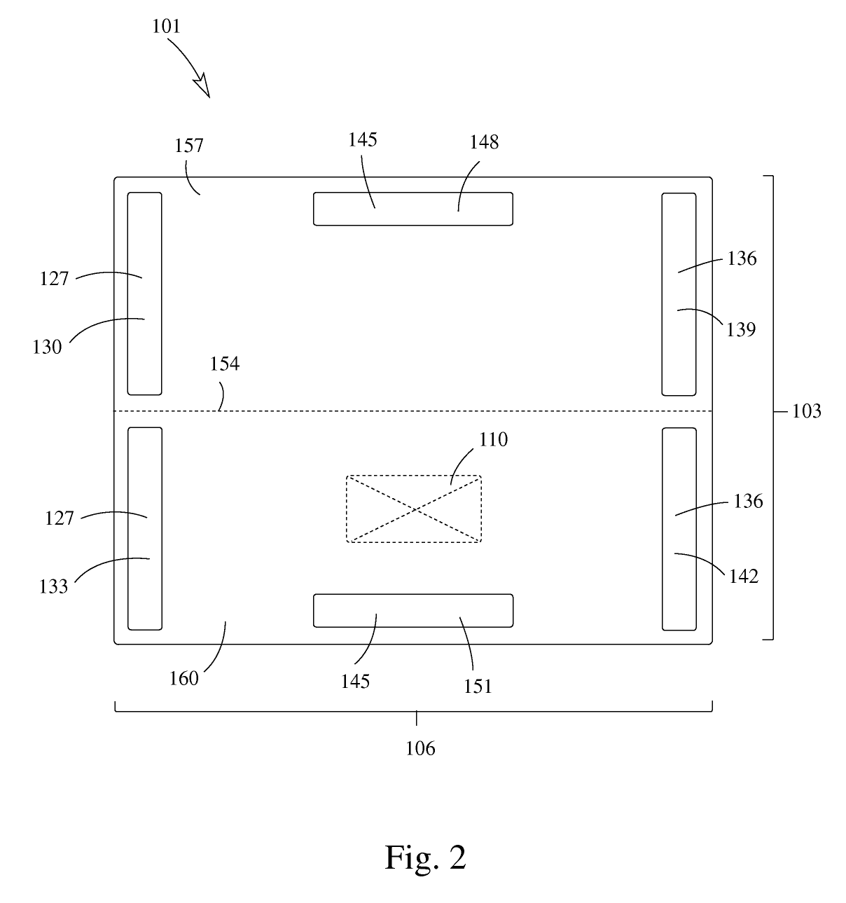

Referring now to FIG. 1A, the present invention in a preferred embodiment preferably comprises strap 1, wherein strap 1 preferably comprises center section 3 with first band 30 preferably disposed on center section 3 at first securing region 24 and second band 39 preferably disposed on center section 3 at second securing region 27. First band 30 is preferably secured to center section 3 by folding first tip 6 over first band 30 forming first fold 8 and preferably stitching first band 30, first central band portion 37 and first fold 8 together at first securing region 24. Second band 39 is preferably secured to center section 3 by folding second tip 9 over second band 39 forming second fold 11 and preferably stitching second band 39, second central band portion 48 (best shown in FIG. 2) and second fold 11 together. One skilled in the art would recognize that although stitching is described in a preferred embodiment, it is meant without limitation and other means of fastening two fabrics together could be utilized. First band 30 preferably further comprises first handle 12 and second handle 15 each preferably disposed at a substantially right angle in relation to center section 3. Second band 39 preferably further comprises third handle 18 and fourth handle 21, wherein third handle 18 and fourth handle 21 are each preferably disposed on center section 3 at second securing region 27 at a substantially right angle. Center section length 4 is preferably approximately 48″ (inches) and first handle length 13, second handle length 16, third handle length 19 and fourth handle length 22 are preferably approximately 7.5″ (inches). Although specific dimensions are described, one skilled in the art would recognize strap 1 could be of different lengths. Strap 1 preferably further comprises first end 7 and second end 10.

Referring now to FIG. 1B, wherein FIG. 1B is representative of both first securing region 24 and second securing region 27, as both are near identical in formation, the stitching at first securing region 24 preferably secures first termination point 33, second termination point 36 and first central band portion 37 with center section 3 at first fold 8. Second securing region 27, third termination point 42, fourth termination point 45 and second central band portion 48 are preferably secured to center section 3 at second fold 11 via stitching. One skilled in the art would recognize first termination point 33 and second termination point 36 could be interchanged and function equivalently as could third termination point 42 and fourth termination point 45.

Referring now to FIG. 2-5, the present invention in a preferred embodiment preferably further comprises pouch 101 for storing strap 1. Pouch 101 is preferably a single piece of material folded at pouch folding line 154 creating pouch upper portion 157 and pouch lower portion 160. Pouch upper portion 157 is fastened to pouch lower portion 160 after folding pouch 101 along pouch folding line 154 by first interior fastener 127, second interior fastener 136 and third interior fastener 145, wherein first interior fastener 127, second interior fastener 136 and third interior fastener 145 are preferably hook-and-loop type fasteners, comprising two cooperating fastening portions, one of hooks and the other of pile. One skilled in the art would recognize that although hook-and-loop type fasteners are specifically contemplated, hook-and-loop type fasteners is not meant to be limiting and other types of temporary fasteners may be utilized. First interior fastener 127 preferably comprises first interior fastener pile 130 preferably disposed on the left periphery of pouch upper portion 157 and first interior fastener hook 133 preferably disposed on the left periphery of pouch lower portion 160. Similarly, second interior fastener 136 preferably comprises second interior fastener pile 139 preferably disposed on the right periphery of pouch upper portion 157 and second interior fastener hook 142 preferably disposed on the right periphery of pouch lower portion 160. Third interior fastener 145 also preferably comprises third interior fastener pile 148 preferably disposed on substantially the center upper periphery of pouch upper portion 157 and further comprises third interior fastener hooks 151 preferably disposed at substantially the center of the lower periphery of pouch lower portion 160. Pouch 101 preferably further comprises outside fastener stitching 110 to preferably secure outside fastener 109 to pouch 101. In a preferred embodiment, pouch width 106 is preferably approximately 18″ (inches) and pouch length 103 is approximately 14″ (inches) to accommodate strap 1 of 48″ (inches); however, pouch 101 may be of any dimension necessary to store strap 1.

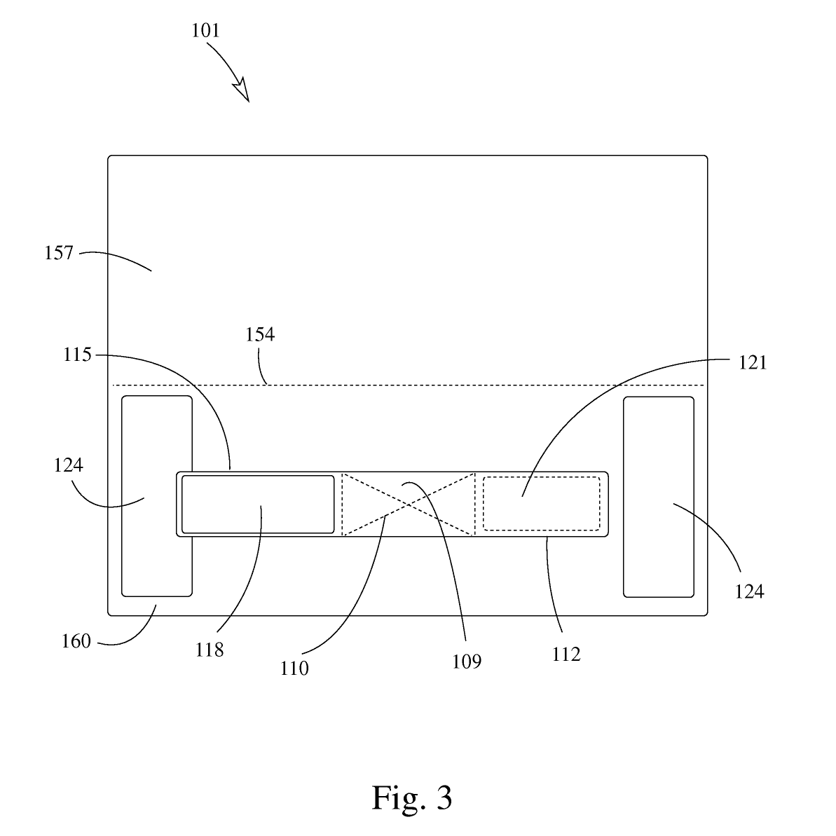

Referring now more particularly to FIG. 3, the outside of pouch 101 is shown and pouch folding line 154 can again be seen dividing pouch 101 into pouch upper portion 157 and pouch lower portion 160. Reflective striping 124 is preferably provided on the outside of pouch 101 to aid visibility, particularly in smoky or dark environments. Outside fastener 109 is preferably disposed on the outside of pouch 101 by outside fastener stitching 110. In a preferred embodiment, outside fastener 109 preferably further comprises outside fastener first end 112 and outside fastener second end 115, wherein outside fastener first end 112 and outside fastener second end 115 preferably comprise hook-and-loop type fasteners. Specifically, outside fastener pile 121 is preferably disposed on outside fastener first end 112 and outside fastener hook portion 118 is preferably disposed on outside fastener second end 115, wherein outside fastener first end 112 and outside fastener second end 115 preferably secure together upon contact.

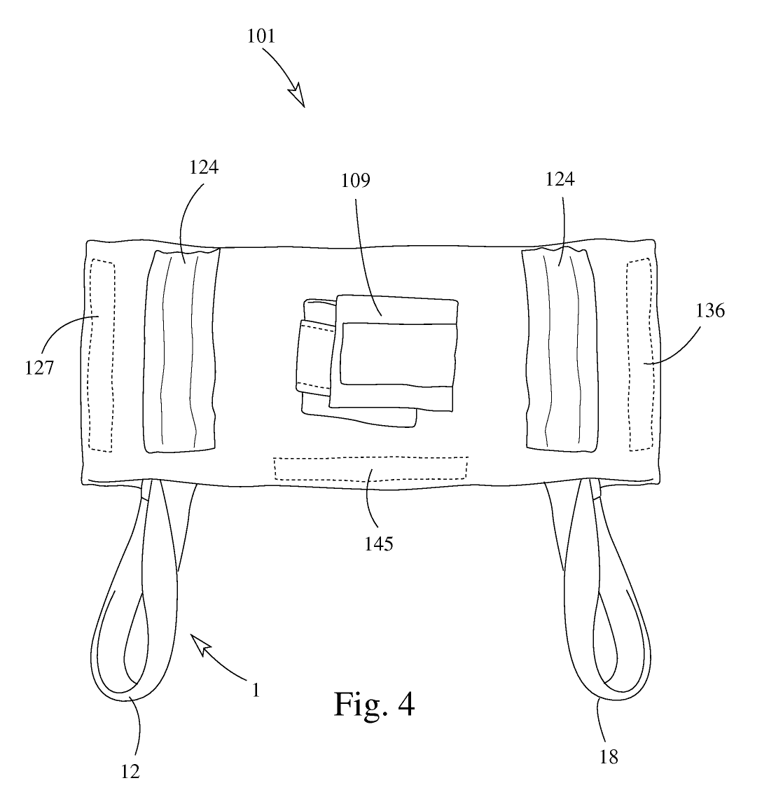

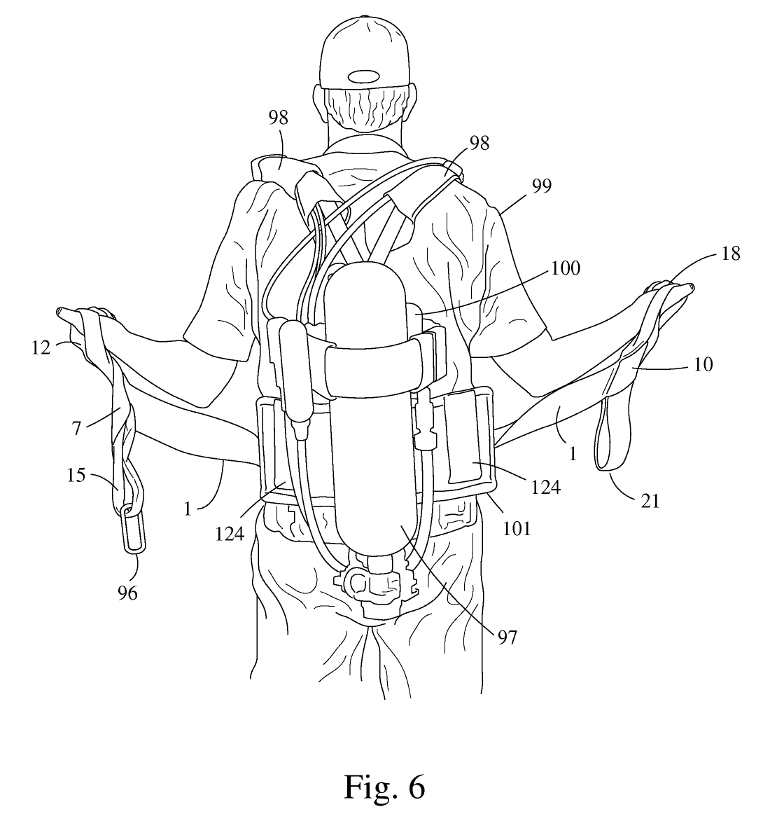

Referring now more particularly to FIG. 4, strap 1 is shown disposed within pouch 101 preferably for storage. In a preferred embodiment, pouch 101 is preferably disposed between S.C.B.A. frame 100 (best shown in FIG. 6) the back of fireman 99 (best shown in FIG. 6), wherein pouch 101 is preferably secured to S.C.B.A. frame 100 via outside fastener 109. First handle 12 of strap 1 preferably protrudes from pouch 101 on one side of pouch 101 and third handle 18 of strap 1 preferably protrudes from pouch 101 on another side of pouch 101 for easy access by fireman 99 or rescue workers. Pouch 101 is preferably securely closed by first interior fastener 127, second interior fastener 136 and third interior fastener 145. Third interior fastener 145 is preferably of sufficient dimensions to allow first handle 12 and third handle 18 to freely protrude from pouch 101. Pouch 101 again preferably comprises reflective striping 124 to aid in visibility and location of pouch 101, fireman 99 wearing pouch 101 and strap 1 contained therewithin. One skilled in the art will recognize that although first handle 12 and third handle 18 are specifically referenced, it would be equally preferable for second handle 15 and fourth handle 21 to protrude from pouch 101. Strap 1, in conjunction with pouch 101, would still function equivalently with second handle 15 and fourth handle 21 protruding and first handle 12 and third handle 18 within pouch 101.

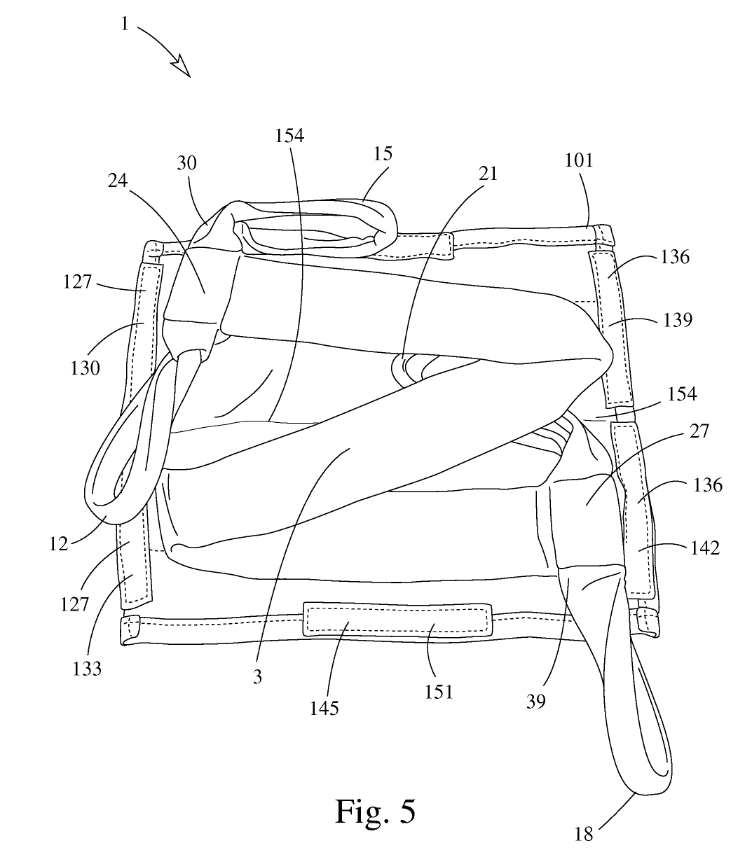

Referring now to FIG. 5, strap 1 is shown in a folded state within open pouch 101. Strap 1 is preferably tri-folded to fit within pouch 101, wherein pouch 101 is of sufficient size and shape to contain strap 1. First securing region 24 of strap 1 is preferably positioned on the left side with second handle 15 folded within pouch 101 while first handle 12 preferably extends outside of pouch 101 in the space created between first interior fastener 127 and third interior fastener 145 when pouch 101 is closed. Likewise, fourth handle 21 on second securing region 27 is preferably stored within pouch 101 when pouch 101 is in the closed position and third handle 18 preferably extends out of pouch 101 through the space created between second interior fastener 136 and third interior fastener 145. Center section 3 of strap 1 preferably extends from first securing region 24 to second securing region 27 forming strap 1 with first band 30 and second band 39. Pouch 101 is preferably closed with strap 1 within by folding pouch upper portion 157 into pouch lower portion 160 along pouch folding line 154 and preferably joining first interior fastener pile 130 with first interior fastener hooks 133 thereby affixing first interior fastener 127, also joining second interior fastener pile 139 with second interior fastener hooks 142 thereby affixing second interior fastener 136, and further joining third interior fastener pile 148 with third interior fastener hooks 151 thereby affixing third interior fastener 145. Folding strap 1 and securing strap 1 within pouch 101 in this manner allows easy and quick access while only pulling on either first handle 12 and/or third handle 18 as further demonstrated in FIG. 6.

Referring now to FIG. 6, first handle 12 and third handle 18 have been pulled from pouch 101 by fireman 99. Although fireman 99 equipped with strap 1 has removed strap 1 from pouch 101, one skilled in the art would recognize others would also be able to simply and quickly remove strap 1 from pouch 101 by pulling in the same manner. This method of deployment is particularly well suited for situations in which fireman 99 is unconscious or otherwise incapacitated or incapable of movement. By pulling on first handle 12 and third handle 18, first end 7 and second end 10 are removed from pouch 101 with second handle 15 and fourth handle 21 hanging freely. First handle 12, second handle 15, third handle 18 and/or fourth handle 21 may optionally have carabiner 96 attached as well. Center section 3 (best shown in FIG. 1) is secured still within pouch 101 underneath S.C.B.A. tank 97 and S.C.B.A. frame 100 and against the back of fireman 99, wherein S.C.B.A. tank 97 and S.C.B.A. frame 100 are secured to fireman 99 and supported via harness 98. Reflective striping 124 can also be seen on pouch 101 making fireman 99 more visible and particularly making pouch 101 more visible for easy location of strap 1 by others. Again, one skilled in the art will recognize that although first handle 12 and third handle 18 are specifically referenced, it would be equally preferable for second handle 15 and fourth handle 21 to be utilized by fireman 99 and protrude from pouch 101. Strap 1, in conjunction with pouch 101, would still function equivalently with second handle 15 and fourth handle 21 protruding and first handle 12 and third handle 18 within pouch 101.

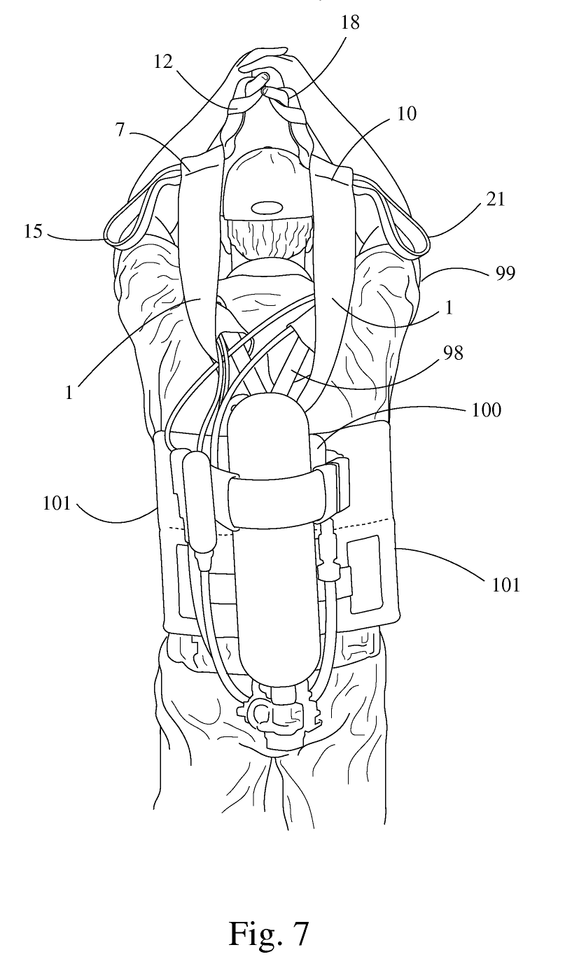

Referring now to FIG. 7, strap 1 has been further deployed, particularly for use when rescuing a fireman 99 who has fallen or otherwise become incapacitated. First end 7 and second end 10 are preferably pulled in a generally upward direction by first handle 12 and third handle 18 so that strap 1 is preferably secured between harness 98 and the back of fireman 99. Pouch 101 can be seen in a fully opened position after forces exerted on strap 1 preferably open pouch 101 by preferably pulling apart first interior fastener 127, second interior fastener 136 and third interior fastener 145 (best shown in FIG. 2). If additional leverage is needed multiple rescuers can pull on first handle 12, second handle 15, third handle 18 and fourth handle 21 to ensure the rescue of fireman 99.

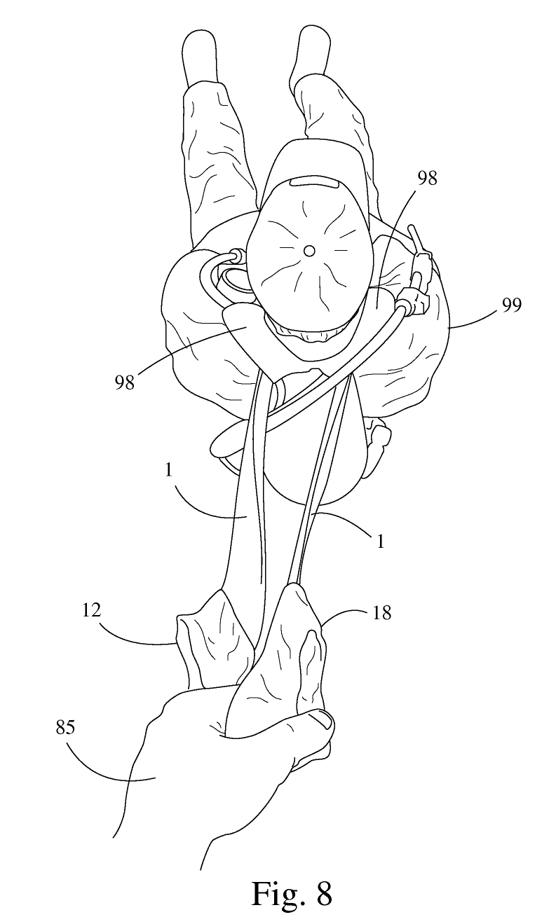

Referring now to FIG. 8, a further preferred use is illustrated in which strap 1, preferably after being secured between the back of fireman 99 and harness 98, strap 1 is utilized to move fireman 99 to safety. In use, rescuer 85 preferably pulls on first handle 12 and third handle 18, thereby pulling on harness 98 attached to fireman 99 and preferably moving fireman 99 generally in a backwards or upwards direction. Again, one skilled in the art will recognize that although first handle 12 and third handle 18 are specifically referenced, it would be equally preferable for second handle 15 and fourth handle 21 to be utilized instead of first handle 12 and third handle 18. Strap 1, in conjunction with pouch 101, would still function equivalently utilizing second handle 15 and fourth handle 21 instead of first handle 12 and third handle 18.

In an alternate embodiment of the method depicted in FIG. 8, subsequent to securing strap 1 between the back of fireman 99 and harness 98, first handle 12 or second handle 15 is passed through the retriever's Drag Rescue Device that is built into retriever's jacket and then secured to either third handle 18 or fourth handle 21. In this fashion the retriever can pull fireman 99 without needing to grasp with the retriever's hands, thereby keeping same free, and further retriever is in a more upright position, thereby increasing the retriever's power for pulling fireman 99.

In a further alternate embodiment of the method of FIG. 8, securing strap 1 could be passed through fireman 99's Drag Rescue Device.

In yet another alternate embodiment of the method of FIG. 8, subsequent to securing strap 1 between the back of fireman 99 and harness 98, securing strap 1 could be passed and secured around the retriever's waist.

In still another alternate embodiment of the method of FIG. 8, subsequent to securing strap 1 between the back of fireman 99 and harness 98, securing strap 1 could be passed and secured around the retriever's SCBA unit.

Yet still another alternate embodiment of the method of FIG. 8, two retrievers could grasp first handle 12 and third handle 18 (or, alternatively, second handle 15 and fourth handle 21) of securing strap 1 and the two retrievers could then pull fireman 99 to safety.

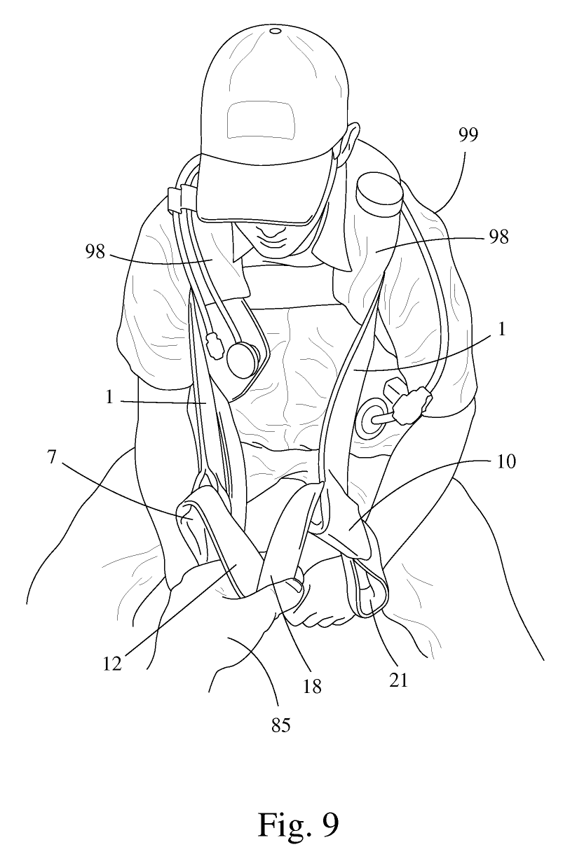

Referring now to FIG. 9, strap 1 is preferably secured between harness 98 and chest of fireman 99 preferably by wrapping first end 7 and second end 10 around at least one portion of harness 98. Rescuer 85 preferably pulls on first handle 12 and third handle 18 thereby pulling fireman 99. Again, one skilled in the art will recognize that although first handle 12 and third handle 18 are specifically referenced, it would be equally preferable for second handle 15 and fourth handle 21 to be utilized instead of first handle 12 and third handle 18.

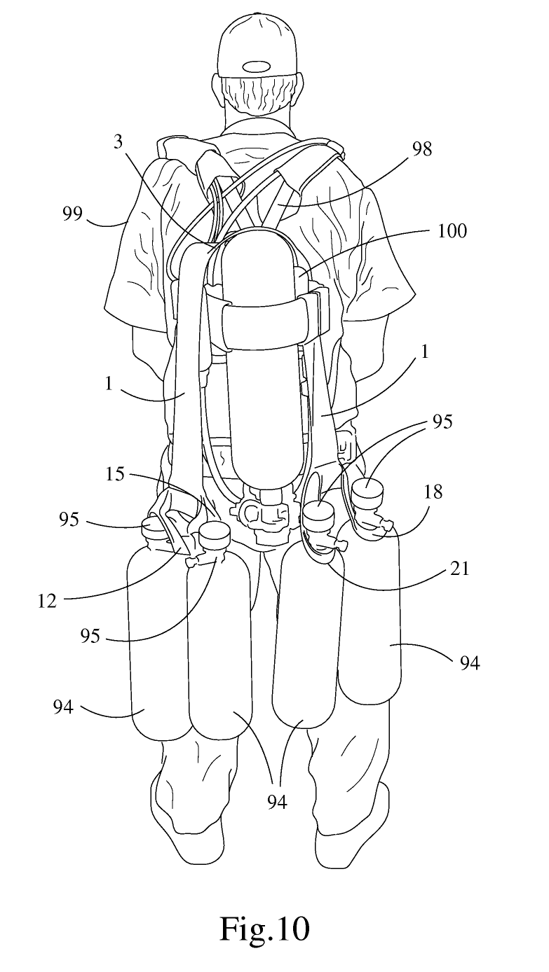

In another preferred use as illustrated in FIG. 10, strap 1 is preferably utilized for carrying multiple S.C.B.A. tanks 94. In use, first handle 12, second handle 15, third handle 18 and fourth handle 21 are preferably secured around S.C.B.A. valve stems 95. Center section 3 of strap 1 is then preferably secured over and around S.C.B.A. frame 100, wherein S.C.B.A. frame 100 is secured to fireman 99 by harness 98. One skilled in the art would recognize strap 1 is equally suited for carrying two S.C.B.A. tanks 94.

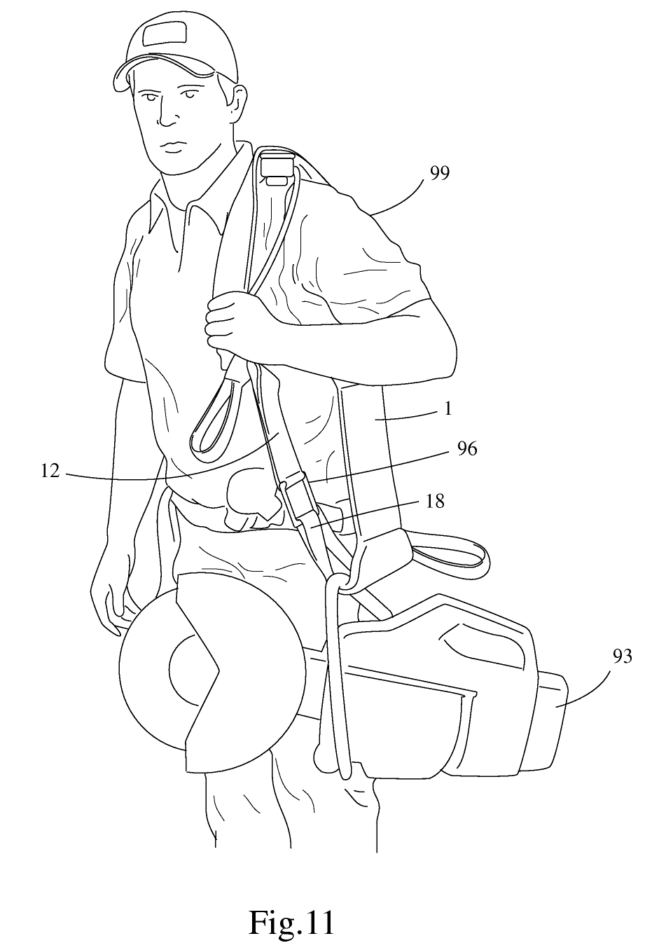

Another preferred use is shown in FIG. 11, wherein strap 1 is preferably slung over the shoulder of fireman 99 and first handle 12 is preferably secured to third handle 18, preferably via carabiner 96, with saw 93 preferably hanging from strap 1. One skilled in the art would recognize that although fireman 99 is specifically referenced as the user of strap 1, fireman 99 is not intended to be limiting and the user need not necessarily be fireman 99. One skilled in the art would similarly realize although saw 93 is specifically referenced, strap 1 may be utilized to secure and assist in carrying many types of devices and saw 93 should not construed as placing a limitation on the use of strap 1. Additionally, one skilled in the art would recognize different combinations of handles 12, 15, 18, 21 could be secured together to carry objects.

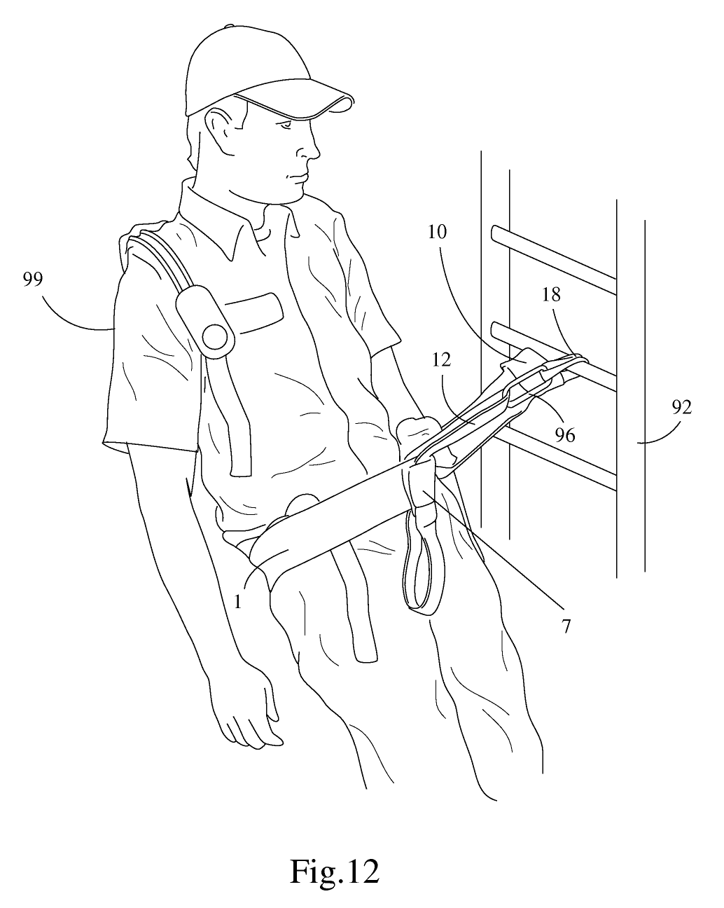

Strap 1 is also preferably utilized as a ladder belt as illustrated in FIG. 12. For use as a ladder belt, first handle 12 is preferably secured to third handle 18, preferably via carabiner 96, after either first handle 12 or third handle 18 is preferably wrapped around and behind ladder 92. First end 7 is also preferably wrapped around one side of fireman 99, wherein first end 7 and second end 10 extend forward of fireman 99. Again, one skilled in the art will recognize that although first handle 12 and third handle 18 are specifically referenced, it would be equally preferable for second handle 15 and fourth handle 21 to be utilized instead of first handle 12 and third handle 18.

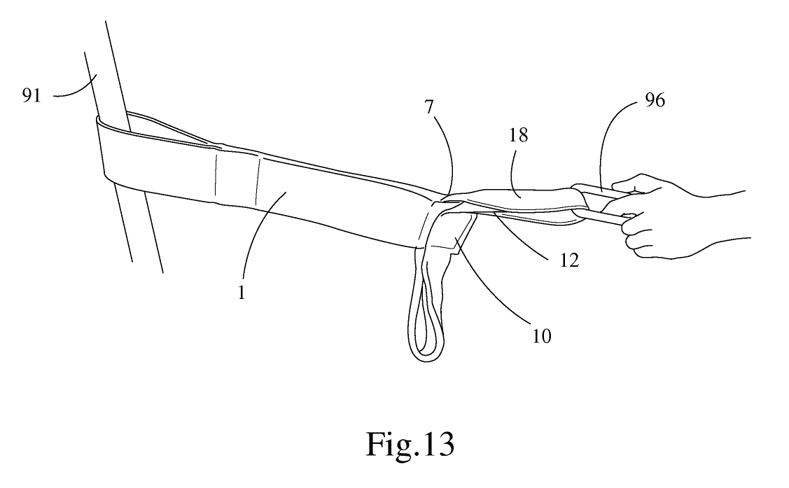

Referring now to FIG. 13, strap 1 is shown utilized as an anchor strap, wherein first end 7 and second end 10 are preferably wrapped around anchor point 91. First handle 12 is optionally secured to third handle 18, preferably via carabiner 96 or similar mechanism. Accordingly, strap 1 or carabiner 96 is preferably utilized to anchor and/or secure an object or person to anchor point 91. Again, one skilled in the art will recognize that although first handle 12 and third handle 18 are specifically referenced, it would be equally preferable for second handle 15 and fourth handle 21 to be utilized instead of first handle 12 and third handle 18.

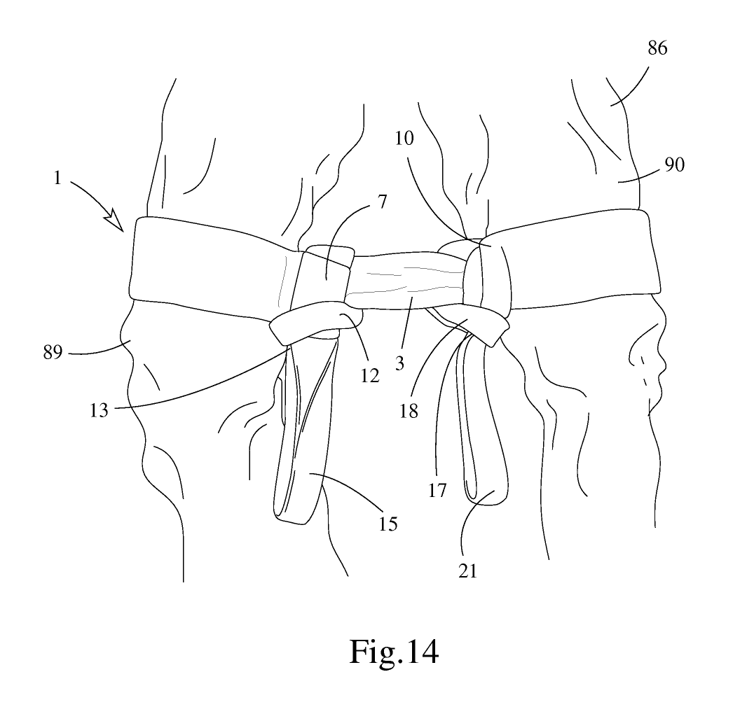

In a further use, strap 1 is preferably utilized as a leg wrap to aid in lifting the legs of rescuee 86 as illustrated in FIG. 14. This functionality is particularly useful for carrying a person up or down stairs, especially when rescuee 86 is not wearing clothing on their legs for fireman 99 (best shown in FIG. 13) to grab. To utilize strap 1 as a leg wrap, center section 3 of strap 1 is preferably placed underneath the legs of rescuee 86. Subsequently, first end 7 is preferably wrapped around first leg 89 and second end 10 is preferably wrapped around second leg 90. Next, first handle 12 is preferably wrapped underneath center section 3 and then second handle 15 is preferably inserted first handle aperture 13. Similarly, third handle 18 is preferably wrapped underneath center section 3 and fourth handle 21 is then preferably inserted through third handle aperture 17. Pulling second handle 15 and fourth handle 21 will preferably tighten first end 7 and second end 10. Lifting second handle 15 and fourth handle 21 preferably lifts first leg 89 and second leg 90 of rescuee 86, thereby making it easier to carry rescuee 86, particularly up or down stairs when one rescuer 85 (best shown in FIG. 9) is carrying rescuee 86 by the shoulders and another rescuer 85 (best shown in FIG. 9) is carrying the legs of rescuee 86. One skilled in the art would recognize, although utilization of strap 1 is described as a leg wrap starting with wrapping center section 3 of strap 1 underneath the legs of rescuee 86, center section 3 could alternatively start on top of legs of rescuee 86 in which case some directions of steps would be reversed. Additionally, one skilled in the art will recognize that although first handle 12 and third handle 18 are specifically referenced, it would be equally preferable for second handle 15 and fourth handle 21 to be utilized instead of first handle 12 and third handle 18.

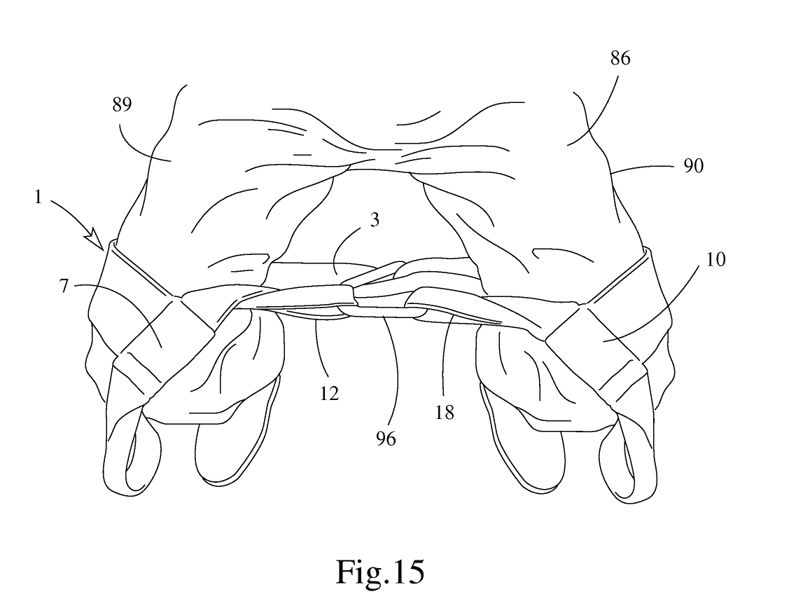

Referring now to FIG. 15, an alternative method of utilizing strap 1 as a leg wrap is illustrated. Similar to the leg wrap described in FIG. 14 of the preceding paragraph, center section 3 of strap 1 is preferably placed underneath first leg 89 and second leg 90 of rescuee 86, first end 7 is preferably wrapped around first leg 89 of rescuee 86 and second end 10 is preferably wrapped around second leg 90 of rescuee 86. First handle 12 is then preferably secured to third handle 18, preferably via carabiner 96. Carabiner 96 may optionally be further secured around center section 3 of strap 1 for increased stability. Again, one skilled in the art would recognize, although utilization of strap 1 is described as a leg wrap starting with wrapping center section 3 of strap 1 underneath the legs of rescuee 86, center section 3 could alternatively start on top of legs of rescuee 86 in which case some directions of steps would be reversed. Further, one skilled in the art will recognize that although first handle 12 and third handle 18 are specifically referenced, it would be equally preferable for second handle 15 and fourth handle 21 to be utilized instead of first handle 12 and third handle 18.

In an alternate embodiment similar to the method of FIG. 15, securing strap 1 could be deployed as depicted in FIG. 6 and first handle 12 and third handle 18 could be secured together via carabiner 96. (It will be recognized that while first handle 12 and third handle 18 are specifically referenced, it would be equally preferable for second handle 15 and fourth handle 21 to be secured together via carabiner 96.) The waist strap of fireman 99's SCBA is unbuckled and one end of same is passed between fireman 99's legs, wherein the waist strap is re-buckled. Subsequently, one of the two remaining handles 15, 21 is placed around the stem of SCBA 97 of fireman 99. Upon standing, the retriever is able to perform a lift of fireman 99, wherein fireman 99's SCBA newly-positioned waist strap prevents fireman 99's SCBA 97 from rising, and wherein the retriever can steady fireman 99 using retriever's now-free hands.

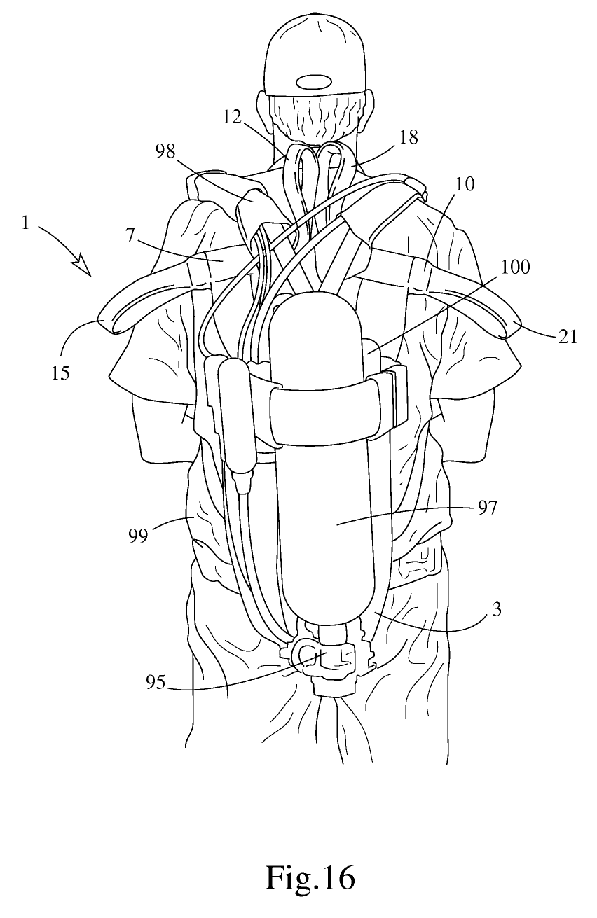

In FIG. 16, a preferred use for strap 1 is shown, wherein strap 1 is preferably secured between harness 98 and back of fireman 99. Center section 3 of strap 1 is preferably secured on S.C.B.A. frame 100 or alternatively may be secured on S.C.B.A. valve stem 95, or between S.C.B.A. tank 97 and S.C.B.A. frame 100 or may remain between back of fireman 99 and harness 98. First end 7 preferably extends generally upward on one side of fireman 99 and second end 10 preferably extends generally upward on the other side of fireman 99. First handle 12 and third handle 18 preferably extend generally upward between straps of harness 98 and second handle 15 and fourth handle 21 preferably generally stick out to either side of fireman 99. In this manner, first handle 12 and third handle 18 can preferably be pulled and will preferably secure on S.C.B.A. tank 97, S.C.B.A. frame 100, S.C.B.A. valve stem 95 and/or harness 98. Second handle 15 and fourth handle 21 can also be pulled on to lift fireman 99. One skilled in the art will recognize that first handle 12, second handle 15, third handle 18 and fourth handle 21 may be pulled on either by rescuer 85 (best shown in FIG. 9) or alternatively may be pulled by cable, wire, rope, similar device and/or any combination thereof. Further, cable, wire, rope and/or similar device may be pulled by people or mechanical means. Additionally, one skilled in the art will recognize that although first handle 12 and third handle 18 are specifically referenced, it would be equally preferable for second handle 15 and fourth handle 21 to be utilized instead of first handle 12 and third handle 18.

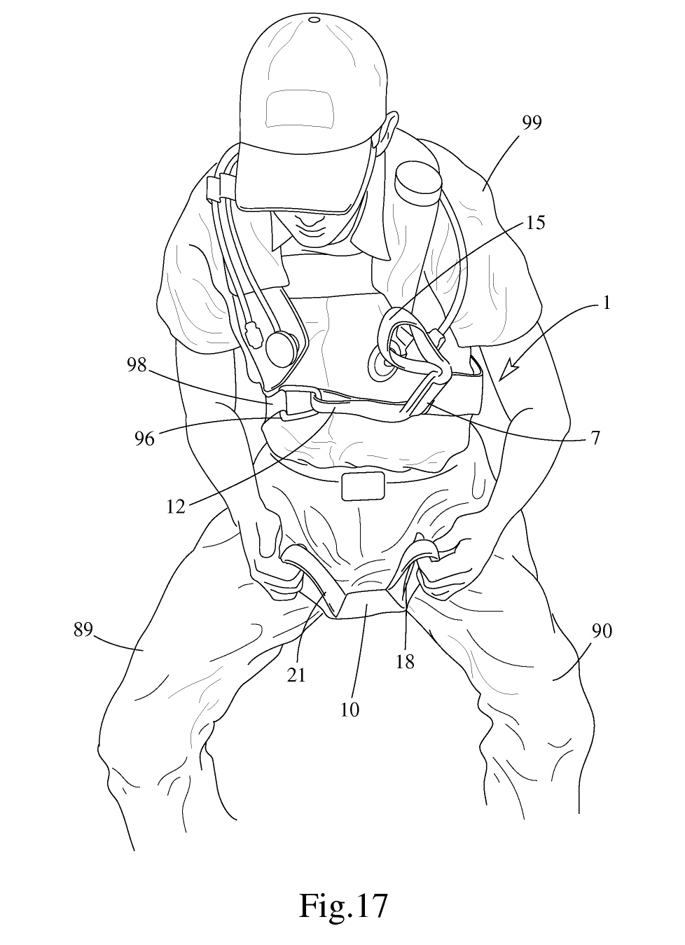

Referring now to FIG. 17, strap 1 is shown utilized as a saddle-type arrangement for lifting fireman 99. First handle 12 on first end 7 is preferably secured to harness 98, preferably via carabiner 96. Second end 10 is preferably wrapped around the body of fireman 99 in the opposite direction from where first handle 12 is preferably secured to harness 98. Second end 10 is then preferably brought generally upward between first leg 89 and second leg 90 of fireman 99. In this manner firefighter is lifted by first handle 12, second handle 15, third handle 18, fourth handle 21 and/or any combination thereof. One skilled in the art will recognize that although first handle 12 and third handle 18 are specifically referenced, it would be equally preferable for second handle 15 and fourth handle 21 to be utilized instead of first handle 12 and third handle 18.

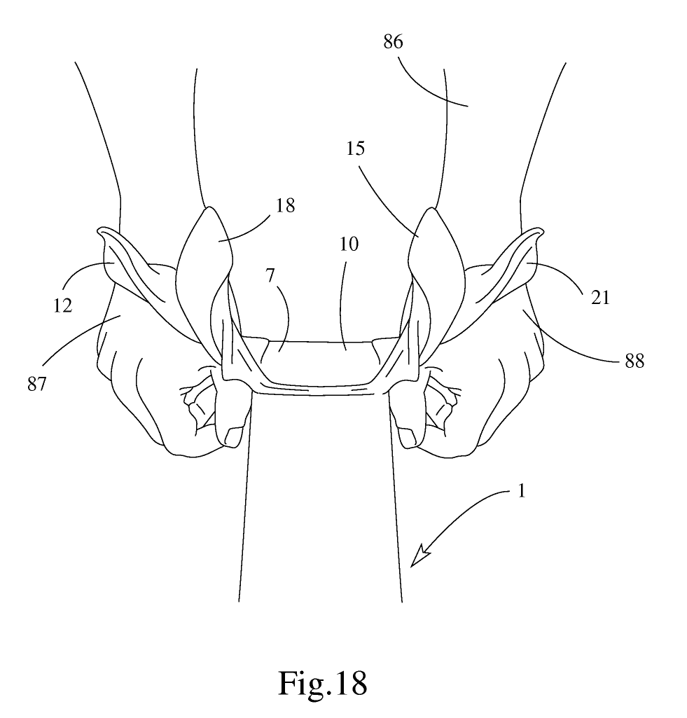

FIG. 18 illustrates strap 1 utilized as a wrist wrap, wherein rescuee 86 is preferably pulled and/or lifted either mechanically or physically by their wrists and/or hands. To secure first hand 87 and second hand 88 with strap 1, first hand 87 is preferably inserted into first handle 12 and second hand 88 is preferably inserted into second handle 15 tightening same against hands, 87, 88, thereby securely retaining hands 87, 88. Second end 10 is preferably passed over first end 7 between first hand 87 and second hand 88, therein preferably twisting first handle 12 and second handle 15. Alternatively, rescuee 86 could preferably move first hand 87 and second hand 88 in a generally circular motion to twist first handle 12 and second handle 15. One skill in the art will recognize that although first handle 12 is specifically mentioned for first hand 87, a user could alternatively put first hand 87 into second handle 15 or utilize third handle 18 and/or fourth handle 21 for either first hand 87 or second hand 88. Additionally, it would also be recognized by one skilled in the art that first end 7 and second end 10 could be utilized as the end on which first hand 87 and right 88 are secured.

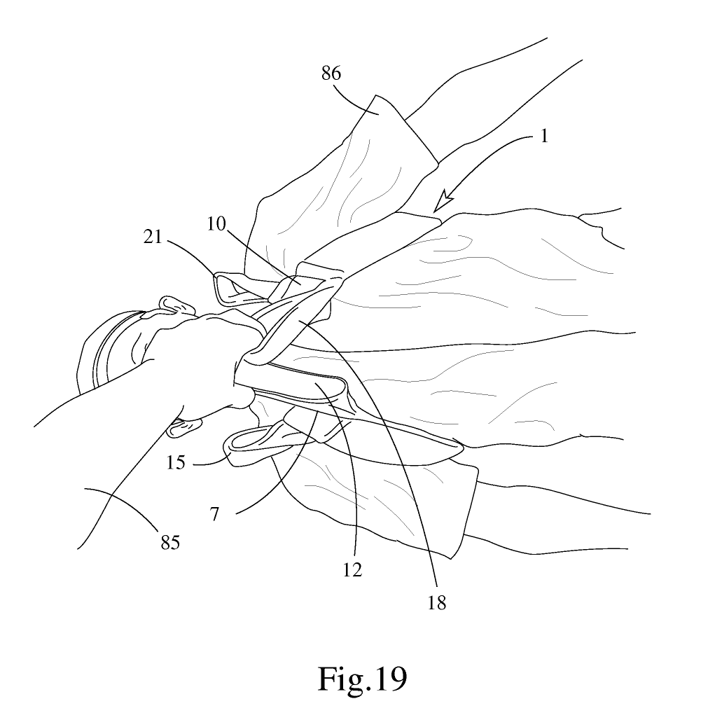

Referring now to FIG. 19, a preferred use of strap 1 is shown for moving a rescuee 86. Center section 3 (best shown in FIG. 1) is preferably placed underneath the torso of rescuee 86 with first end 7 and second end 10 preferably rising generally upward on either side of rescuee 86. Rescuer 85 then preferably pulls on first handle 12 and third handle 18 to move rescuee 86. One skilled in the art would recognize rescuer 85 could also pull on other combinations of first handle 12, second handle 15, third handle 18 and fourth handle 21, including all handles 12, 15, 18, 21, in this preferred use so long as handles 12, 15, 18, 21 being pulled are on opposite ends 7, 10 of strap 1. It would also be recognized by one skilled in the art center section 3 of strap 1 may in contact with either the front or back of rescuee 86.

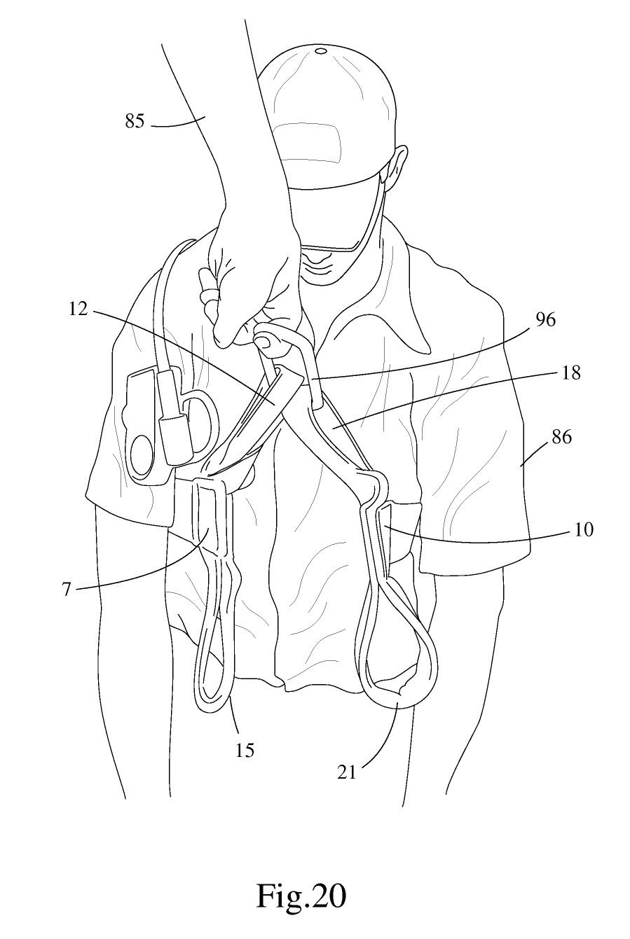

FIG. 20 shows a preferred use of strap 1 similar to that illustrated in FIG. 19. Center section 3 (best shown in FIG. 1) is preferably placed underneath the torso of rescuee 86 with first end 7 and second end 10 preferably rising generally upward on either side of rescuee 86. First handle 12 and third handle 18 are then preferably secured to each other, preferably with carabiner 96, and rescuer 85 preferably pulls to move rescuee 86 or alternatively, rope, cable, wire or similar object is secured to carabiner 96 to preferably move rescuee 86. Again, one skilled in the art would recognize carabiner 96 could secure other combinations of first handle 12, second handle 15, third handle 18 and fourth handle 21, including all handles 12, 15, 18, 21, in this preferred use so long as handles 12, 15, 18, 21 being pulled are on opposite ends 7, 10 of strap 1. It would also be recognized by one skilled in the art center section 3 of strap 1 may in contact with either the front or back of rescuee 86 and that rope, cable, wire or similar object is not meant to be limiting and are exemplary of types of hoisting devices which may be utilized in conjunction with strap 1.

The foregoing description and drawings comprise illustrative embodiments of the present invention. Having thus described exemplary embodiments of the present invention, it should be noted by those skilled in the art that the embodiments within disclosures are exemplary only, and that various other alternatives, adaptations and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are utilized in a generic and descriptive sense only and not for purposes of limitation. Accordingly, the present invention is not limited to the specific embodiments illustrated herein, but is limited only by the following claims.

What is claimed is:

1. A method of using a strap, wherein said method comprises the steps of:
obtaining a strap having a first end, a second end and a center section, wherein said first end comprises a first handle and a second handle, and wherein said second end comprises a third handle and a fourth handle;
wrapping said first end and said second end of said strap around a user;
wrapping said first handle of said first end of said strap around a portion of a ladder; and
securing said first handle disposed on said first end of said strap to said second handle disposed on said second end of said strap, whereby the portion of the ladder is encircled by said first end of said strap.

2. A method of using a strap, wherein said method comprises the steps of:
obtaining a strap having a first end, a second end and a center section, wherein said first end comprises a first handle and a second handle, and wherein said second end comprises a third handle and a fourth handle;
wrapping a first end of said strap around an anchor point; and
securing said first end of said strap to a second end of said strap, whereby the anchor point is encircled by said strap.

3. A method of moving an object, said method comprising the steps of:
obtaining a strap having a first end, a second end and a center section, wherein said first end comprises a first handle and a second handle, and wherein said second end comprises a third handle and a fourth handle;
securing said strap to the object; and
pulling said strap to move the object.

4. The method of claim 3, further comprising the steps of:
inserting a first hand into said first handle of said strap;
inserting a second hand into said second handle of said strap;
passing said second end of said strap over said first end of said strap; and
pulling on said second end of said strap, thereby tightening said first handle around said first hand and tightening said second handle around said second hand.

5. The method of claim 3, wherein said securing step further comprises the steps of:
wrapping said first end of said strap around an object; and
securing said first end of said strap to said second end of said strap.

6. The method of claim 3, further comprising the steps of:
securing a frame to a person, wherein said frame is secured to the person via a harness;
securing a pouch to said frame, wherein said pouch contains said strap, and wherein said first handle of said strap and said third handle of said strap protrude from said pouch;
pulling said first handle, wherein said pulling removes said first end of said strap from said pouch;
pulling said third handle, wherein said pulling removes said second end of said strap from said pouch, thereby disposing said first handle on a first rear side of the person and said third handle on a second rear side of the person;
pulling said first handle and said third handle in a substantially upward direction, thereby securing said strap to said harness; and
pulling said first handle and said third handle of said strap, thereby applying force to move the person.

7. The method of claim 3, further comprising the steps of:
securing a harness to a person;
securing said first end of said strap to said harness;
wrapping said second end of said strap across the body of the person;
pulling said second end of said strap between the legs of the person, thereby creating a saddle in which the person is seated; and
pulling said second end of said strap to move the person.

8. The method of claim 3, further comprising the steps of:
placing said center section of said strap under the legs of a person;
wrapping said first end of said strap around a first leg of the person;
wrapping said second end of said strap around a second leg of the person;
wrapping said first handle disposed on said first end underneath said center section of said strap;
inserting said second handle disposed on said first end of said strap through said first handle disposed on said first end of said strap;
wrapping said third handle disposed on said second end underneath said center section of said strap;
inserting said fourth handle disposed on said second end of said strap through said third handle disposed on said second end of said strap;
pulling said second handle disposed on said first end of said strap through said first handle disposed on said first end of said strap, thereby tightening said strap around said first leg;
pulling said fourth handle disposed on said second end of said strap through said third handle disposed on said second end of said strap, thereby tightening said strap around said second leg; and
lifting said second handle and said fourth handle to lift the legs of the person.

9. The method of claim 3, further comprising the steps of:
wrapping said first end and said second end of said strap around a person; and
pulling said first end and said second end of said strap to move the person.

10. The method of claim 9, further comprising the steps of:
securing said first end of said strap to said second end of said strap.

11. The method of claim 9, wherein said pulling is in a substantially vertical direction.

12. The method of claim 9, wherein said pulling is in a substantially horizontal direction.

13. The method of claim 9, wherein said pulling is accomplished by a rope.

14. The method of claim 9, wherein said pulling is accomplished by a person.

15. The method of claim 9, wherein said pulling is accomplished by a machine.

16. The method of claim 3, wherein said securing step further comprises the steps of:
inserting a first object to be transported into at least one handle on said first end of said strap; and
inserting a second object to be transported into at least one handle of said second end of said strap.

17. The method of claim 3, further comprising the steps of:
placing said center section of said strap under the legs of a person;
wrapping said first end of said strap around a first leg of the person;
wrapping said second end of said strap around a second leg of the person;
securing said first end of said strap to said second end of said strap; and
lifting said first end of said strap and said second end of said strap to lift the legs of the person.

18. The method of claim 17, further comprising the step of:
securing said first end of said strap and said second end of said strap to said center section of said strap.

19. The method of claim 3, further comprising the steps of:
wrapping said first end and said second end of said strap through a harness, wherein said harness is secured to a person; and
pulling said first end and said second end of said strap to move the person secured to said harness.

20. The method of claim 19, further comprising the steps of:
securing said first end of said strap to said second end of said strap.
